(19) United States
(12) Patent Application Publication
(10) Pub. No.: US 2003/0064149 A1
(43) Pub. Date: Apr. 3, 2003

(54) Methods of applying coatings to micro electromechanical devices using a carbon dioxide carrier solvent

(76) Inventor: Seth A. Miller, Dallas, TX (US)

Correspondence Address: TEXAS INSTRUMENTS INCORPORATED, P O BOX 655474, M/S 3999, DALLAS, TX, 75265

(21) Appl. No.: 10/241,999

(22) Filed: Sep. 12, 2002

Related U.S. Application Data
(60) Provisional application No. 60/325,739, filed on Sep. 28, 2001.

(51) Int. Cl. B05D 5/06

(52) U.S. Cl. 427/126.3; 118/300; 427/67

(57) ABSTRACT

A method of coating one or more surfaces of a micromechanical device. The coating is applied as a material dissolved in CO2. The CO2 is used a carrier solvent, with the coating being applied as a spray or in liquid form, to form a film on the surface. The CO2 may be used in supercritical form to dissolve the material.

### TECHNICAL FIELD OF THE INVENTION

This invention relates to micro electromechanical systems (MEMS), and more particularly to applying films to such devices using carbon dioxide (CO2) as a carrier solvent.

### BACKGROUND OF THE INVENTION

Today's microelectromechanical systems (MEMS) contain parts so small they are measured in nanometers. One problem encountered with successful operation of MEMS device is friction, such as friction associated with their tiny motors, pumps and gears.

Various efforts have been made to reduce such friction. For example, MEMS manufacturers have found ways to bake lubricants onto the surface of microdevices at high temperatures. Studies have also been made of various micro-thin coatings for MEMS devices.

Examples of such coatings are described in U.S. Pat. No. 6,259,551 B1, entitled “Passivation for Micromechanical Devices”, U.S. Pat. No. 5,512,374 entitled “PFPE Coatings for Micro-Mechanical Devices” and U.S. Patent Serial No. 60/301,984 entitled “Lubricating Micro-Machine Devices Using Fluorosurfactants”. These patents and patent application are assigned to Texas Instruments Incorporated. They each describe coatings and lubricants for MEMS devices, and particularly describe such coatings as used for digital micro-mirror devices (DMD 10s).

Prior methods of applying lubricants have used fluorocarbons as a carrier solvent for the lubricating material. However, fluorocarbons tend to be expensive and involve environmental issues.

### SUMMARY OF THE INVENTION

One aspect of the invention is a method of coating surfaces of a micro-mechanical device. The material from which the coating is made is dissolved in carbon dioxide (CO2). Using the CO2 as a carrier solvent, dissolved material is then deposited on at least one exposed surface of the device. The dissolved material may be applied with the CO2 in liquid form or with the CO2 in a supercritical state.

An advantage of the invention is that the use of CO2 as a solvent and carrier has minimal environmental impact. CO2 solvents are low cost, and minimize solvent residue and the need for solvent recapture.

### BRIEF DESCRIPTION OF THE DRAWINGS

FIG. 1 illustrates a DMD in an undeflected state.

FIG. 2 illustrates a DMD with its mirror in a deflected position and contacting a landing surface to which the mirror may adhere.

FIG. 3 illustrates a DMD to which a lubricating film has been applied in accordance with the invention.

FIG. 4 is a process flow diagram for the back-end fabrication of a MEMS device that is lubricated with a coating in accordance with the present invention.

### DETAILED DESCRIPTION OF THE INVENTION

For purposes of example, the following description is in terms of a particular type of improved micro-mechanical device, namely an improved DMD 10. As previously described, a DMD 10 includes one or more—typically an array of many thousands—selectively movable, tiny mirrors 11 which selectively reflect (or not) incident light to an image plane or other site. An array of DMD 10's may be used to selectively form images. The present invention obviates the sticking or adhesion of the mirrors 11 to landing electrodes 17, which are contacted by the mirrors 11.

Images formed by the DMD 10 can be used in display systems and for non-impact printing applications. Non-image-forming applications of DMD 10's include optical steering and switching and accelerometers. In some of these applications, the mirror 11 need not function as such and, accordingly, need not be reflective. Also, in some applications, the DMD 10 is not operated in a digital mode. In general, then, “DMD 10” as used herein is intended to encompass any type of micro-mechanical device having selectively movable elements that contact or engage, and may stick or adhere to, another element. Similarly “mirror” may mean any mass, reflective or not, which moves incidental to the operation of the micro-mechanical device.

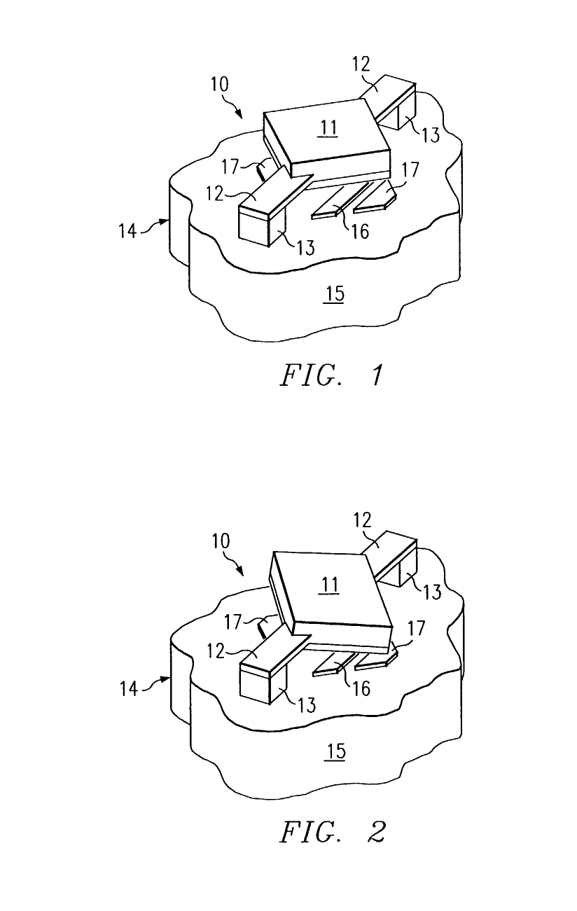

FIGS. 1 and 2 illustrate a single DMD 10. In FIG. 1, the mirror 11 is in its normal or undetected position, in which the mirror 11 may, as shown, be generally parallel to the surface of a substrate 15. In FIG. 2, the mirror 11 has been selectively moved or deflected in a binary manner to a position whereat the edge of the mirror 11 engages and contacts the landing electrode 17 acting as a stop. As noted above, a typical DMD 10 SLM may have an array of hundreds or thousands of such mirrors 11, each of which reflects or does not reflect incident light to a selected site depending on its undeflected or undeflected position.

The DMD 10 of FIGS. 1 and 2 is a torsion beam DMD 10, because its mirror 11 is supported by torsion beams 12. Other types of DMD 10's can be fabricated, such as cantilever types and flexure types, and including those fabricated with so-called “hidden hinges.” In the hidden hinge design, the hinge assembly is on a level under the mirror, and may include a yoke under the mirror that lands on the landing electrodes instead of the mirror tips doing so. Various types of DMD 10's are described in commonly assigned U.S. Pat. Nos. 4,662,746, 4,956,610, 5,061,049 and 5,083,857 each incorporated by reference herein.

In operation for display and other applications, radiant energy, such as visible light, from a source thereof (not shown) illuminates the DMD 10. Appropriate lens systems (not shown) may be used to confine the radiant energy to within the border of the array of DMD 10's to direct the radiant energy onto the mirrors 11. Each movable mirror 11 is supported by torsion beams 12 attached to support posts 13. The mirrors 11 are positioned over a control or address/memory circuit 14, which is fabricated on a silicon substrate 15. The control circuits 14 selectively apply selected voltages to control electrodes 16 formed on the substrate 15. The support posts 13 are formed on and extend away from the substrate 15.

Electrostatic forces between the mirrors 11 and their control electrodes 16 are produced by selective application of selected voltages to the control electrodes 16 and the mirrors 11. These voltages may be based on the data in memory cells of address/memory circuit 14. In a particular type of DMD 10, operation is achieved by rotating the mirrors 11 about axes coincident with the torsion beams 12 out of the normal position (in which the mirror 11 is “on”) about 10%. In the rotated position, the mirror 11 is “off.” The pattern of “on” and “off” mirrors 11 in the array modulates the incident light. Light reflected from the “on” mirrors 11 is directed to a selected site via various display optics (not shown). Light from the “off” mirrors 11 is deflected away from the selected site.

If the control circuit 14 has two control electrodes 16 the mirror 11 may be capable of occupying any one of three positions. Specifically, the rotation of the mirror 11 may be tristable, that is, fully rotated and “stopped” against a landing electrode 10° clockwise or counterclockwise or in the normal position.

Each mirror 11 and its associated control electrode 16 form a capacitor, with each element serving as a capacitor plate. When appropriate voltages are applied to the control electrodes 16 and to the mirror 11, the electrostatic force (attractive or repulsive) produced therebetween causes the mirror 11 to move toward one or the other of the landing electrodes 17 until an edge of the mirror 11 abuts and contacts the appropriate landing electrode.

Once the electrostatic force between the control electrode 16 and the mirror 11 is eliminated, the energy stored in the beams 12 biases the mirror 11 back toward the normal position. Appropriate voltages may be applied to the various elements, to aid in returning the mirror 11 to its normal position.

As alluded to above, if the mirror 11 and the landing electrode 17 stick or adhere, the mirror 11 may fail to return to its normal position for that reason. Elimination or ameliorating such sticking or adhesion and/or the effects thereof is one goal of the present invention.

As described in U.S. Pat. No. 5,512,374, referenced above and incorporated by reference herein, various coatings may be applied to surfaces of a DMD 10 to alleviate adhesion between contacting elements. For example, a film of oil-like perfluoropolyether, also known as PFPE, may be deposited on those portions of the mirrors 11 and their control electrodes which contact or engage. U.S. Pat. No. 5,512,374 describes various types of PFPE's that may be deposited as a film on DMD elements to ameliorate or eliminate sticking or adhesion.

Another suitable coating is a coating made from a perfluorodecanioc acid (PFDA). Many other fluorocarbons might also be useful. A characteristic of fluorocarbons is that they are soluble in CO2. The use of fluorosurfactants is-described in U.S. Patent Serial No. 60/301,984, referenced above and incorporated by reference herein.

The present invention is directed to the use of CO2 as a solvent for a coating, which may be a lubricant such as PFPE or PFDA or some other type of lubricant or any other type of coating for a purpose other than, or in addition to, lubrication. Much of the following description is in terms of PFPE coating materials, but the same concepts may be applied to other fluorocarbon materials.

FIG. 3 illustrates a process of applying a coating 31 in accordance with the invention. For purposes of example, a DMD 10 is illustrated, but the process of the invention may be used to advantage with respect to any micro-mechanical device having relatively movable elements which contact or engage and which thereafter experience sticking or adhesion. In the case of fabricating DMD 10's, the process may be performed on an individual DMD 10, simultaneously on an array of DMD 10's, or on a wafer on which have been formed numerous DMD 10 arrays, the wafer being eventually separated into chips, each having one array of DMD 10's. The process of FIG. 3, which permits application of the coating simultaneously to large numbers of DMD 10's is especially suited for volume production and is easily integrated into the process flow for making DMD 10's or other micro-mechanical devices. In FIG. 3, the DMD 10's have been fabricated and include the landing electrodes 17, the address electrodes 16, the mirrors 11, the beams 12, and the supports 13.

The coating material is dissolved in liquid or supercritical CO2, which is used as the primary carrier solvent. The CO2 is first liquefied for dissolution purposes and may be converted to supercritical state under appropriate pressure and temperature conditions. A feature of using CO2 as a solvent in this manner is that it may be applied entirely under high pressure conditions as a liquid or it may be returned to atmospheric pressure and applied as a spray. Thus, using the CO2 solvent, the coating may be deposited as a vapor by vapor deposition at low pressure or by thermal evaporative techniques, as a fine mist or an aerosol or other sol produced by an appropriate mechanism such as a nebulizer or atomizer. The coating may alternatively be applied as a liquid film resulting from dipping or spinning.

Deposition of the coating material results in a film 31 on exposed surfaces of the DMD 10, including the portions of the mirrors 11 and the landing electrodes 17 that contact or engage during operation of the DMD 10. The advantages of the present invention may be realized if the film 31 is deposited on only one of the potentially adherent element portions, though practically speaking such selective deposition may be difficult to achieve.

The thickness of the film 31 when deposited as a vapor or spray is a function of the time during which the DMD 10 is exposed thereto, as well as a function of molecular weight, viscosity, vapor pressure and reactivity of the particular coating material selected. If desired, monolayer films may be obtained on time scales ranging from seconds to minutes.

Regardless of whether film 31 is applied as a liquid or spray, it should be sufficiently thick to ensure its chemical stability. Specifically, it has been found the if the relatively movable elements of a micro-mechanical device, such as the mirror 11 and the landing electrode 17, are made of typical materials, such as aluminum having an oxidized surface, and if typical procedures, such as plasma etching in an oxygen+NF₃ atmosphere, have been previously utilized, a film on such surfaces may become decomposed or degraded by breaking down or becoming unstable. It has further been found, however, that if the film is sufficiently thick, the non-stick, non-adhesion effects of the film are not compromised. In the case of a PFPE film, stability may be due to the ability of the PFPE, which is deposited as a film after (and on top of) an initial monolayer film thereof to remain stable when it is in contact with the now degraded or decomposed initial monolayer (i.e., decomposed by the aluminum oxide surface and/or by residual compositions resulting from prior processing steps), the degraded or decomposed PFPE, in effect, passivating the surface.

Giving consideration to all of the foregoing, as well as to the topography and roughness of the surfaces receiving a film 31, a suitable thickness of the film has been found to be in the range of approximately 5 angstroms to approximately 100 angstroms. A particular type of material may be selected for a particular micro-mechanical device by giving due consideration to factors such as inter-facial stability, chemical stability, and thermal stability. In general, selection of the coating material is a function of the material of the surface to which the coating is to be applied, the history of this surface as determined by the integrated circuit processing steps previously effected, and the environment in which the micro-mechanical device will operate. For inter-facial stability, a material is chosen that is not completely degraded over time due to reaction with the underlying material.

In the case of DMD 10's having aluminum mirrors 11 and landing electrodes 17 with aluminum oxide skins or surfaces, suitable PFPE's include acetal-deficient PFPE's, including Y-type PFPE's, and acetal-free Krytox or Demnum, and mixtures of acetal-free and acetal-deficient PFPE's. Z25-type PFPE, an acetal-rich PFPE, has also been found to be effective for use with DMD 10's. Acetal-rich PFPE films may exhibit some of the previously discussed decomposition of the initially deposited monolayer film thereof resulting in a passivated surface, so that subsequent layers of the film are stable and achieve the benefits of this invention. Indeed, an initial monolayer film of an acetal-rich PFPE may first be deposited, followed by deposition of subsequent film layers of another PFPE to produce the film.

Chemical stability of the film 31 may be encouraged by incorporating selected chemical functional groups in the PFPE material to be deposited, so that PFPE film will bond to the surfaces to which it is applied. These functional groups include hydroxyl, ether, phenolic, and carboxylic groups, among others. For example, where the surface to which PFPE film is applied is aluminum oxide, a carboxylic group is suitable because it can chemically bond with the surface.

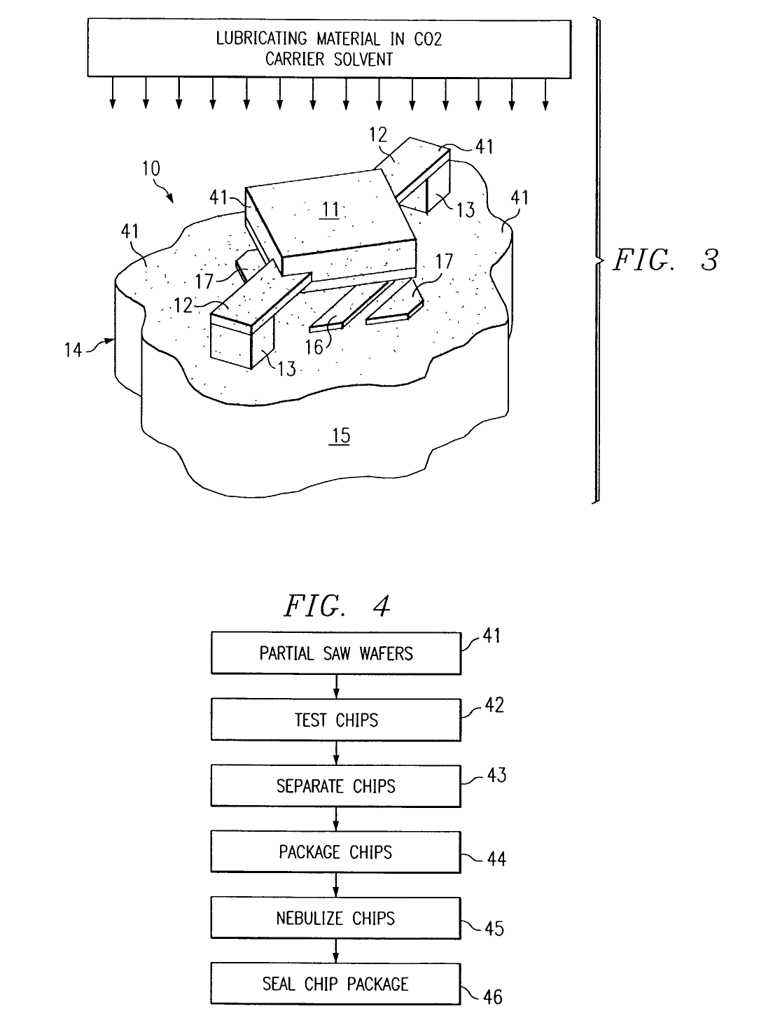

FIG. 4 illustrates the back-end fabrication process of a MEMS device, such as an array of DMD elements 10, which is lubricated with a material dissolved in and carried by CO2 in accordance with the invention. The process is comprised of fabricating wafers 40 of the MEMS device having moving parts, partially sawing 41 the devices apart, but leaving them slightly attached, testing 42 the individual chips on the wafer, completing the sawing 43 of the chips, packaging 44 the individual chips, nebulizing 85 the chips by spraying them with a fine mist of the CO2 dissolved and carried coating material, and attaching 86 lids or cover glasses to the packages. Although the nebulizing step is shown at the device level, it could alternatively be performed at the wafer level.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the scope of the invention.

What is claimed is:

1. A method of coating at least one surface of a micro-mechanical device, comprising the steps of:
dissolving a coating material in CO2; and
depositing the dissolved material on at least one exposed surface of the device.

2. The method of claim 1, wherein the CO2 is in liquid form.

3. The method of claim 1, wherein the CO2 is in a supercritical state during the dissolving step only.

4. The method of claim 1, wherein the CO2 is in a supercritical state during the dissolving step and the depositing step.

5. The method of claim 1, wherein the depositing step is performed by vapor deposition, thermal evaporation, nebulization, dipping, or spinning.

6. The method of claim 1, wherein the depositing step is performed by spraying the dissolved material

7. The method of claim 5, wherein the spraying is performed with a nebulizer.

8. The method of claim 1, wherein the micro-mechanical device is of the type having a first element selectively movable relative to a second element, portions of the elements contacting in one position of the first element, and wherein the depositing step is performed so as to coat at least one of the elements.

9. The method of claim 1, wherein at least one of the surfaces includes aluminum oxide.

10. The method of claim 1, wherein the depositing step results in a film of about 5 angstroms to about 100 angstroms thick.

11. The method of claim 1, wherein the coating material is primarily a fluorocarbon material.

12. The method of claim 1, wherein the coating material is primarily a perfluoropolyether (PFPE).

13. The method of claim 12, wherein the perfluoropolyether (PFPE) is Z-type, Y-type, Krytox or Demnum.

14. The method of claim 12, wherein the perfluoropolyether (PFPE) has incorporated thereinto as functional chemical groups carboxylic, hydroxyl, ether or phenolic groups.

15. The method of claim 1 wherein the coating material is acetal-deficient, acetal-free or acetal-rich perfluoropolyether (PFPE) or a mixture of two or more thereof.

16. The method of claim 1, wherein the coating material is a perfluorodecanoic acid (PFDA).

17. A MEMS device operable for modulating light having lubricated moving parts, comprising:
a silicon substrate having CMOS memory circuitry;
address electrodes and landing pads fabricated over the silicon substrate;
a hinge assembly fabricated over the silicon substrate;
a mirror attached to the hinge assembly;
wherein the hinges are operable to rotate in response to electrostatic forces resulting from electrical activation of the address electrodes; and
wherein the surfaces of at least the landing pads are lubricated with a material dissolved in and carried by CO2.

18. The device of claim 17, wherein the hinges are torsion hinges on the same level as the mirror.

19. The device of claim 17, wherein the hinge assembly is located at a level lower than the mirror.

20. A back-end process for fabricating MEMS devices with lubricated micro-machined parts, comprising the steps of:
fabricating a wafer of the MEMS devices;
partially sawing the wafer;
testing the wafer;
completing sawing of the wafer, thereby separating the wafer into individual devices;
packaging the devices; and
applying a lubricating material to exposed surfaces of the devices by applying a nebulized solution to the devices, the solution being comprised of at least one coating material dissolved in and carried by CO2.
